(19) United States
(12) Patent Application Publication
(10) Pub. No.: US 2012/0268268 A1
(43) Pub. Date: Oct. 25, 2012

(54) MOBILE SENSORY DEVICE

(76) Inventor: John Eugene Bargero, Sausalito, CA (US)

(21) Appl. No.: 13/308,486

(22) Filed: Nov. 30, 2011

Related U.S. Application Data
(60) Provisional application No. 61/477,149, filed on Apr. 19, 2011.

(51) Int. Cl. G08B 1/08

(52) U.S. Cl. 340/539.11

(57) ABSTRACT

A remote sensory device used in conjunction with a handheld device , such as a PDA (Personal Data Assistant) that utilizes its various computational and telephonic properties as well as other features such as its; short-wave transceiver, display and human interface, electrical power, texting, internet and web browsing capabilities The sensory device utilizes a variety of sensors both individually and in combination to detect physical phenomenon, such as temperature, humidity, gases, radiation, sounds, light, object proximity ,and the like and convert them into an electronic signal that can be interpreted, analyzed, stored and transmitted by the hand-held device and presented to the user. The remote sensory device may be stand alone or imbedded into a case suitable for the PDA and may transfer the data either through a radio means or through a direct electrical connection.

### PRIORITY

This invention claims the priority date of provisional application Ser. No. 61/477,149 filed on Apr. 19, 2011.

### BACKGROUND OF THE INVENTION

1. Field of Invention

The invention relates to the field of detecting, processing, and transmitting information that can be quantitatively measured, more specifically towards a device that can perceive external stimuli and transmit them to a remote device for processing and global transmission, such as a PDA.

2. Related Art

Currently the explosion in the use of mobile technology has transformed the mobile phone into a data acquisition device. That is, current PDA's or personal data assistants and smart phones do much more than make phone calls and send emails, through sensors built into the devices, such as accelerometers and GPS (global positioning systems) and in combinations with various computer programs or application the phone can now be use to calculate the users speed and acceleration for example.
Unfortunately, there needs to be a sensor that can read or sense varying phenomenon in order for the applications or programs to interpret them and present them to the user for his or her benefit. Because different phenomenon requires difference devices to sense them, such as a thermometer would sense temperature, while a Geiger counter tube would sense radiation, it is not practical, nor at times desirable to incorporate a multitude of sensors into the mobile device. Furthermore, in the instance of directly integrating a breath—alcohol analyzer with a smart phone may have some undesirable negative effects, such as being ostracized by peers and potential legal or evidentiary pitfalls.

### BRIEF SUMMARY

The invention provides one generally a remote sensory device used in conjunction with a handheld device , such as a PDA (Personal Data Assistant) or smart phone that utilizes its various computational and telephonic properties as well as other features such as its; short-wave transceiver, display and human interface, electrical power, texting, internet and web browsing capabilities The sensory device utilizes a variety of sensors both individually and in combination to detect physical phenomenon, such as temperature, humidity, gases, radiation, sounds, light, object proximity ,and the like and convert them into an electronic signal that can be interpreted, analyzed, stored and transmitted by the hand-held device and presented to the user. The remote sensory device may be stand alone or imbedded into a case suitable for the PDA and may transfer the data either through a radio means or through a direct electrical connection.

Other aspects and advantages of the present invention will become apparent from the following detailed description which when taken in conjunction with the drawings, illustrates by way of example the principles and structure of the invention.

### BRIEF DESCRIPTION OF THE DRAWINGS

Taking the following specifications in conjunction with the accompanying drawings will cause the invention to be better understood regarding these and other features and advantages. The specifications reference the annexed drawings wherein:

FIG. 1 is a front perspective view of a mobile sensory device.

FIG. 2 is a block diagram of the functionality of a mobile sensory device.

### DETAILED DESCRIPTION OF THE PREFERRED EMBODIMENTS

According to one general embodiment, mobile sensory device, the device comprises of a sensory unit that detects environmental occurrences and converts them into an electrical signal, such as a changing in resistance, an increase or decrease in current, or an increase or decrease in voltage. Typical sensors of this type are on the market and can detect anything from alcohol, various gases, temper, radiation, humidity and just about any perceivable occurrence. By taking advantage of the computer processing power of the smart phone or PDA and packaging the sensor without any power supply and computational circuitry or by minimizing the use thereof it allows for very compact, small and inexpensive devices.

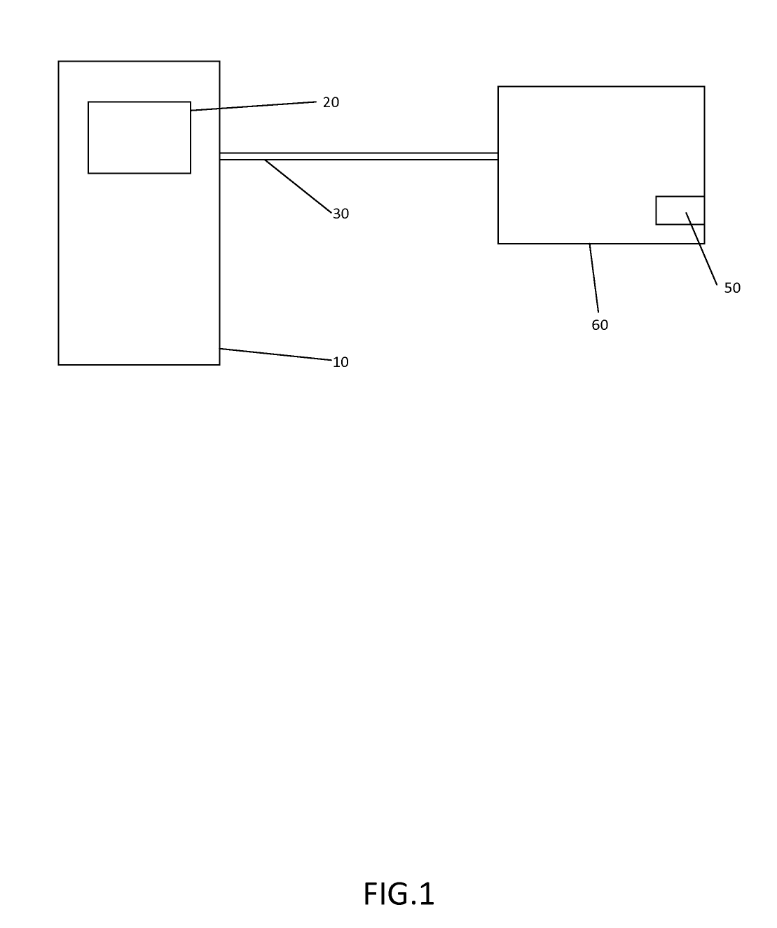

Referring to FIG. 1 a preferred embodiment uses a PDA 10 that has a visible display 20 and a female connector 30, this connector typically interfaces with a USB cable to power the device and to transmit data to and from, a cable 40 that connects between the female connector 40 and the sensor 50 which is in a case 60 in one embodiment the case is made of plastic or rubber.

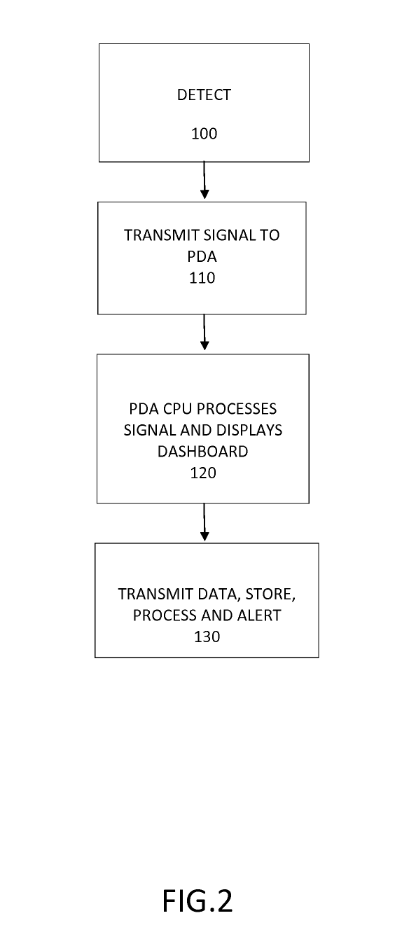

Referring to FIG. 2 a preferred embodiment is displayed in a block diagram, wherein the sensor detects the item to be measures 100, transmits the data to the smart phone 110, the signal is processed by the smart phone's processor and displayed on the device's display either visually or audibly 120 and then the processed data is either stored or transmitted from the device 130.

There are a multitude of ways in which this combination of sensor and PDA can be applied; in one embodiment the sensor plugs into the smart phone, either through the charging port or the ear phone port or female receptor directly either through a cable or a direct mount wherein the body of the sensor further comprises a male plug integrated therein.

In an alternative embodiment the sensor is built into a case that attaches to the smart phone and so appears to be part of the phone itself.

In another alternative embodiment the sensor utilizes a short wave radio to transmit data to and from the PDA, such as the Blue Tooth protocol currently used by most phones, this would require additional circuitry, such as a transmitter and possibly receiver as well as a power supply which may add to the size, complexity and cost of the sensor, but would allow maximum portability and transferability between PDAs. Furthermore it would allow the sensor to be remote or detached such as in the case of a breathalyzer application wherein the sensor could be left in an automobile and the individual would use it when he or she contemplated driving after a cordial or two.

In another embodiment it has been contemplated to utilize the calling and data transferring capabilities of the smart phone. Wherein a sensor, such as, for carbon monoxide or similar poisonous gas is positioned near the phone or attached thereto and in the event of gas detection or other hazard detected by the sensor, the smart phone would notify the user by an audible alarm and if the user does not respond within a predetermined time frame the application in the phone would automatically notify the proper authorities and in combination with the GPS function of the phone give them an accurate location of the potential victim. This application would be particularly valuable to travelers that may reside in transient locals, such as hotels or motels because normal 911 (emergency response stations) would not know exactly where the user is without the GPS location information.

In another embodiment, the PDA is used in conjunction with a breath-alcohol analyzer and when a threshold is passed the phone would automatically alert pre-selected persons that could counsel or possibly provide transportation to the person in the event that he or she is inebriated.

Furthermore, in alternative embodiments it has been contemplated to store the measured data with additional data, like time, location, and frequency, so that forensic research can be done to discern patterns or habits. This data can then be used to modify one's behavior, for example if a blood sugar sensor is incorporated into the device one could track patterns of when and where the levels fall out of the accepted range. As well if a blood pressure sensor were incorporated, one would be aware of where and when one's blood pressure were elevated and would be able to avoid those locals or persons to maintain a healthy lifestyle. These are just a few examples of sensed and recorded data that could be used to modify or improve one's life.

Other embodiments utilizes a variety of sensors both individually and in combination to detect physical phenomenon, such as temperature, humidity, gases, radiation, sounds, light, object proximity ,and the like and convert them into an electronic signal that can be interpreted, analyzed, stored and transmitted by the hand-held device and presented to the user. The remote sensory device may be stand alone or imbedded into a case suitable for the PDA and may transfer the data either through a radio means or through a direct electrical connection.

The invention has been described in terms of the preferred embodiment. One skilled in the art will recognize that it would be possible to construct the elements of the present invention from a variety of means and to modify the placement of the components in a variety of ways. While the embodiments of the invention have been described in detail and shown in the accompanying drawings, it will be evident that various further modifications are possible without departing from the scope of the invention as presented in the following claims.

1. A mobile sensory device comprising:
a sensor;
a handheld device that incorporates computing, telephonic, short wave radio transmission and reception, internet and web browsing capabilities;
a means of transmitting data from the sensor to the handheld device, and;
a series of computer code to interpret the transmitted data to the human interface of the handheld device.

2. The mobile sensory device of claim 1 further comprising a short-wave transceiver and power supply electronically connected to the sensor.

3. The mobile sensory device of claim 2 wherein the means of transmitting the data from the sensor is a short-wave transmitter.

4. The mobile sensory device of claim 1 wherein the means of transmitting data is an electrical wire electronically connected between the sensor and the handheld device.

5. The mobile sensory device of claim 1 wherein the sensor further comprises a male plug configured to be inserted into the handheld device.

6. The mobile sensory device of claim 1 wherein in the sensor is embedded into a case which is configured to surround the handheld device.

7. The mobile sensory device of claim 1 wherein the sensor is an alcohol sensor.

8. The mobile sensory device of claim 1 wherein the sensor is a radiation detector.

9. The mobile sensory device of claim 1 wherein the sensor is a carbon monoxide sensor.

10. The mobile sensory device of claim 1 wherein the sensor is a sound volume sensor.

11. The mobile sensory device of claim 1 wherein the sensor is a gas detector.

12. The mobile sensory device of claim 1 wherein the sensor is proximity sensory.

13. The mobile sensory device of claim 1 wherein the sensor is a photo-cell.

14. The mobile sensory device of claim 1 wherein the sensor is an atmospheric pressure sensor.

15. The mobile sensory device of claim 1 wherein the sensor is a thermometer.

16. The mobile sensory device of claim 3 wherein the series of computer code activates the telephonic properties of the handheld device to call a predetermined number when a certain threshold signal is received from the sensor.

17. The mobile sensory device of claim 3 wherein the series of computer code activates the telephonic properties of the handheld device to transmit a short wave signal when a certain threshold signal is received from the sensor.

18. The mobile sensory device of claim 3 wherein the series of computer code that processes and stores the data from the sensor.
